(19) United States
(12) Patent Application Publication
(10) Pub. No.: US 2026/0014530 A1
(43) Pub. Date: Jan. 15, 2026

(54) SYNTHESIS OF MEMBRANES GRAFTED WITH AMINE-MODIFIED METAL OXIDE FOR WATER TREATMENT

(71) Applicants: SAUDI ARABIAN OIL COMPANY, Dhahran (SA); King Fahd University of Petroleum and Minerals, Dhahran (SA)

(72) Inventors: Tawfik A. SALEH, Dhahran (SA); Norah W. ALJURYYED, Dhahran (SA); Abadi A. MUTAIRI, Dhahran (SA)

(73) Assignees: SAUDI ARABIAN OIL COMPANY, Dhahran (SA); King Fahd University of Petroleum and Minerals, Dhahran (SA)

(21) Appl. No.: 18/769,559

(22) Filed: Jul. 11, 2024

(51) Int. Cl. B01D 71/78; B01D 67/00; B01D 69/12; B01D 71/34; B01D 71/56; C02F 1/44; C02F 101/20; C02F 101/22; C02F 101/32; C02F 103/08; C02F 103/36

(52) U.S. Cl. CPC B01D 71/78; B01D 67/0011; B01D 69/12; B01D 71/34; B01D 71/56; C02F 1/44; B01D 2323/12; B01D 2323/21834; B01D 2323/2187; B01D 2323/2189; B01D 2323/36; B01D 2323/38; C02F 2101/20; C02F 2101/22; C02F 2101/32; C02F 2103/08; C02F 2103/365

(57) ABSTRACT

Methods of producing membranes, and membranes for metal and/or hydrocarbon removal. The methods include synthesizing an amine-modified metal oxide, wherein the amine-modified metal oxide comprises a metal oxide component and a water-soluble amino acid derivative having a 1:1 ratio of metal oxide components to water-soluble amino acid derivative; dissolving a water-soluble polymer and a polyvinylidene fluoride and the amine-functionalized metal oxide to form a polymer solution; casting the polymer solution into a mold to form a substrate membrane; coating the substrate membrane with a polyamide; and forming a membrane, wherein the amine-functionalized metal oxide is covalently connected to the polyvinylidene fluoride.

### FIELD OF THE DISCLOSURE

The present disclosure relates generally to membranes for the treatment of wastewater and, more particularly, to the method of producing membranes that include polyvinylidene fluoride (PVDF) and polyamide, in which the polyvinylidene fluoride is grafted with amine-functionalized metal oxide.

### BACKGROUND OF THE DISCLOSURE

The global water shortage has resulted from population growth and industrialization and is a key challenge that humanity faces in the 21st century. Continuous progress on wastewater treatment technologies has been made to improve water reuse and reduce water shortages. Among them, the development of thin-layer membranes, working as selective agents between two phases and regulating the permeability of substances, has made tremendous progress.

### SUMMARY OF THE DISCLOSURE

For water treatment, membrane-based separation methods are very essential owing to long-term efficiency, high mechanical stability and durability. The filtration process with polymer-inorganic and organic composite is an outstanding strategy that enhances the properties of both inorganic materials such as thermal and mechanical stability and organic material including flexibility and processability of the membranes. Therefore, the surface wettability of the membranes is vital for pollutants separation.

Accordingly, ongoing needs exits for the development of membranes capable of removing metals and hydrocarbons from wastewater. Embodiments of this disclosure include methods of producing membranes, and membranes for metal and/or hydrocarbon removal. The methods include synthesizing an amine-modified metal oxide, wherein the amine-modified metal oxide comprises a metal oxide component and a water-soluble amino acid derivative having a 1:1 ratio of metal oxide components to water-soluble amino acid derivative; dissolving a water-soluble polymer and a polyvinylidene fluoride and the amine-functionalized metal oxide to form a polymer solution; casting the polymer solution into a mold to form a substrate membrane; coating the substrate membrane with a polyamide; and forming a membrane, wherein the amine-functionalized metal oxide is covalently connected to the polyvinylidene fluoride.

Other embodiments includes methods for treating wastewater. The methods include flowing wastewater through a membrane comprising a polyamide and polyvinylidene fluoride grafted with an amine-functionalized metal oxide. The amine-functionalized metal oxide comprises a metal oxide component and a water-soluble amino acid derivative having a 1:1 ratio of metal oxide components to water-soluble amino acid derivative.

One or more embodiments of this disclosure includes a membrane comprising: polyamide and polyvinylidene fluoride grafted with an amine-functionalized metal oxide, wherein the amine-functionalized metal oxide comprises a metal oxide component and a water-soluble amino acid derivative having a 1:1 ratio of metal oxide components to water-soluble amino acid derivative.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a bar graph of percent rejections of various salts using the membrane of this disclosure.

FIG. 2 is a bar graph of percent rejections of various metals using the membrane of this disclosure.

FIG. 3 is a bar graph of percent rejections of various hydrocarbon using the membrane of this disclosure.

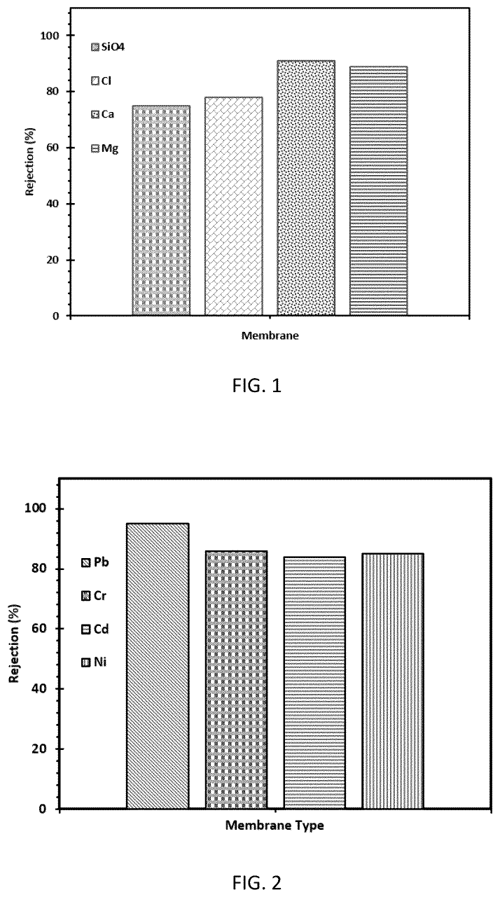

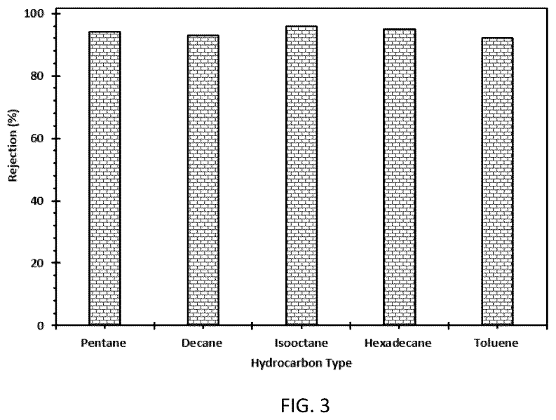

### DETAILED DESCRIPTION

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to membranes for the treatment of wastewater and, more particularly, to the method of producing membranes that include polyvinylidene fluoride (PVDF) and polyamide, in which the polyvinylidene fluoride is grafted with amine-functionalized metal oxide.

Embodiments of the present disclosure include methods of producing a membrane. The method includes: synthesizing a amine-modified metal oxide, wherein the amine-modified metal oxide comprises a metal oxide component and a water-soluble amino acid derivative having a 1:1 ratio of metal oxide components to water-soluble amino acid derivative; dissolving a water-soluble polymer and a polyvinylidene fluoride and the amine-functionalized metal oxide to form a polymer solution; casting the polymer solution into a mold to form a substrate membrane; coating the substrate membrane with a polyamide; and forming a membrane, wherein the amine-functionalized metal oxide is covalently connected to the polyvinylidene fluoride.

In some embodiments, the methods of producing the membrane include washing the polymer the substrate membrane. When the membrane is washed, the water-soluble polymer may be fixed in/on other polymers by hydrogen bonding. Without intent to be bound by theory, it is believed that the fascinating properties of hydrophilic Al—OH or the Al structure ended with OH groups or NH₂ groups that can form hydrogen bonds with the water-soluble polymer immobilizing water-soluble polymer on PVDF membranes.

When the membrane is casted, the mold may be any two-dimensional shape. For example, the mold may be a petri dish or a container that may hold the polymer solution.

Embodiments of the present disclosure include a membrane comprising polyamide and polyvinylidene fluoride grafted with an amine-functionalized metal oxide. In some embodiments, the membrane optionally includes a water-soluble polymer.

The amine-functionalized metal oxide is grafted to the polyvinylidene fluoride via a halogen exchange. The amine of the amine-functionalized metal oxide replaces a fluorine atom in the PVDF.

The amine-functionalized metal oxide includes the metal oxide component and the water-soluble amino acid derivative. In some embodiments, the metal oxide component comprises a silane derivative. The metal oxide of the metal oxide component may be covalently connected to the silane and include a primary amine resulting the following Formula I:

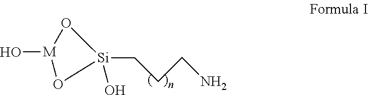

In formula (I), M is a metal chosen from boron, aluminum, gallium, silicon, iron, and manganese; subscript n is 1 to 10. As shown in formula (I), the mole ratio of aluminum to the primary amine is 1 to 1.

The metal oxide component may be covalently connected to water-soluble amino acid derivative through a hydroxyl group of the metal oxide component.

The amine-functionalized metal oxide includes a 1:1 ratio of metal oxide components to water-soluble amino acid derivative.

In some embodiments, the water-soluble amino acid derivative may include various amino acids coupled with heterocyclic hydrocarbon. The water-soluble amino acid derivative may include amino acids coupled with a pterin ring. In some embodiments, the amino acid derivative may be folic acid.

In various embodiments, the amine-modified aluminum oxide comprises a structure according to formula (II), wherein the primary amine of the amine-modified aluminum oxide is covalently bonded to PVDF, as shown in Formula II:

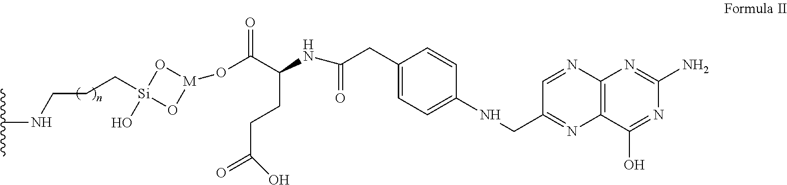

In Formula (II), M is a metal chosen from boron, aluminum, gallium, silicon, iron, and manganese; subscript n is 1 to 10; and the molar ratio of metal, M, to silica is 1 to 1. When M is silica, the molar ratio of silica to the folic acid derivative is 2:1.

In one or more embodiments, the water-soluble polymer is polyvinylpyrrolidone. In some embodiments, the polyamide is an aliphatic polyamide, polyphthalamide, paraphenylenediamine, polypeptides, polyesters, polyimide amide, or pyrrole-imidazole polyamides.

Some embodiments include methods for treating wastewater. The method of treating wastewater may include flowing wastewater through a membrane comprising a polyamide and polyvinylidene fluoride grafted with an amine-functionalized metal oxide. The amine-functionalized metal oxide includes a metal oxide component and a water-soluble amino acid derivative having a 1:1 ratio of metal oxide components to water-soluble amino acid derivative. The amine-functionalized metal oxide may also include a primary amine component.

The wastewater may be a byproduct from industrial oil refinery, and may contain various metals, oils, salts, or combinations thereof.

### EXAMPLES

Examples 1 to 3 are directed to the synthesis and production of the polyvinylidene fluoride membrane grafted with amine functionalized metal oxide. Examples 4-5 are the results of the membranes produced from examples 1 to 3.

### Example 1—Synthesis of Amine Modified Aluminum Oxides Precursor

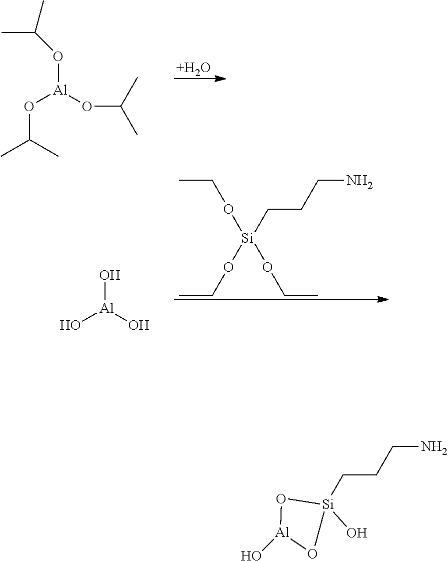

Aluminum oxide nanoparticles were synthesized by the hydrolysis of aluminum isopropoxide, Al(OC₃H₇)₃, in deionized water with a ratio of 1 mole alkoxide in 200 mole of water. Approximately 2 ml of 0.1 M sodium hydroxide was added. This process was carried out at 90° C. under stirring for about 4 hours. Then, the product was separated by centrifuge at 8000 rpm, and then dried.

Then, 2 g of the obtained modified aluminum oxides were incorporated with 10 mL 3-(aminopropyl)triethoxysilane (APTES) followed by 3 hours of ultrasonic treatment. The mixture was kept under reflux at 750° C. for 4 h. Afterward, the mixture was separated allowed to dry at 80° C. to obtain the white Al-APTES powder.

### Example 2—Synthesis of the Amine Modified Aluminum Oxides

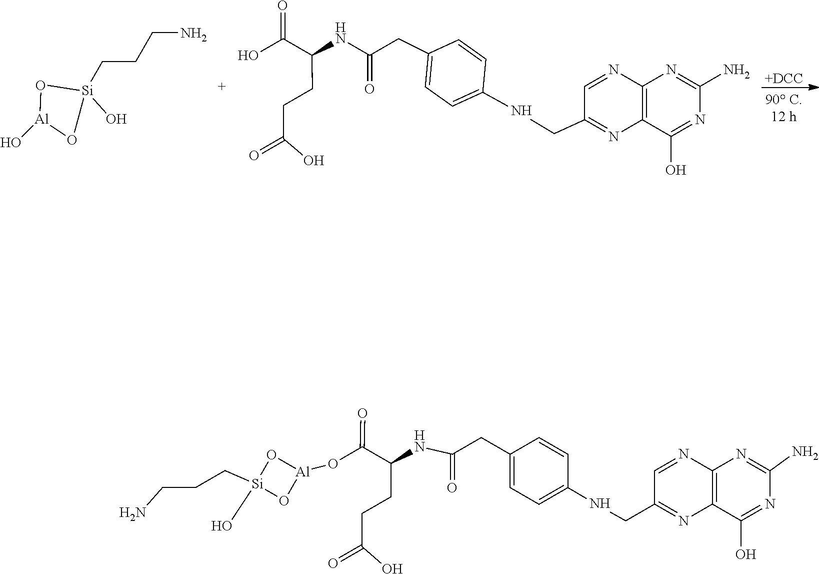

The collected Al-APTES powder was dispersed in 35 mL ethanol, and 4 g folic acid (FA) was added while stirring. for 3 hours After that, 4 mL of H₂SO₄ was drop-wise added. Then, 0.1 g of N,N′-Dicyclohexylcarbodiimide (DCC or DCCD) was added as catalyst, under the flow of nitrogen (N₂) gas inlet for 5 minutes to remove any water droplets. The system was stirred for 12 h at 90° C. Finally, the modified materials were separated and dried overnight.

### Example 3—Synthesis of Membranes with Amine Modified Aluminum Oxides

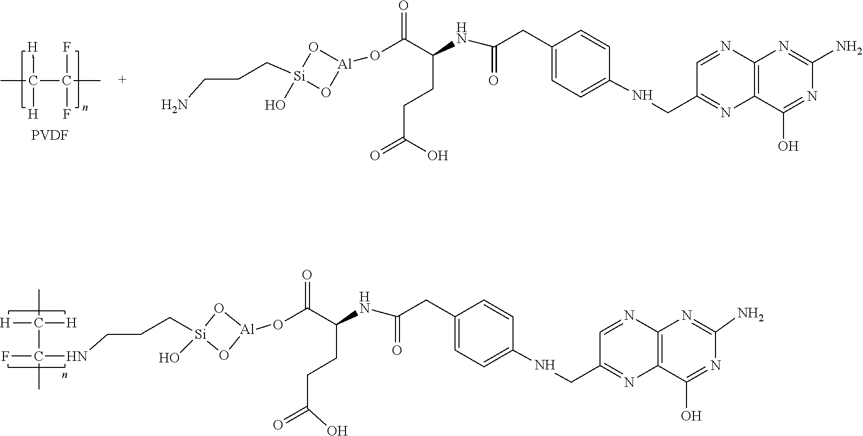

The Polyvinylidene fluoride (PVDF) casting solution was prepared by dissolving about 2 g of PVDF and 0.3 g of polyvinylpyrrolidone (PVP), and 0.5 g of the prepared amines-based branches modified aluminum oxides as additive in 20 mL dimethylformamide (DMF) as a solvent. It was kept then under stirring for 24 h in a closed inert environment.

An appropriate amount of this solution was uniformly distributed onto a glass plate using a casting knife. Then, after 2 min, the formed sheet was placed straight into the water bath in order to cause PVDF precipitation. The generated membrane was rinsed with deionized water and kept in water for a day in order to remove any remaining solvents. The obtained wet membrane was allowed to dry in the vacuum oven at 35° C.

The prepared PVDF substrate was then used as a support and a film layer of polyamide was then formed on it. More specifically, an aqueous solution was prepared of 5 wt. % the phenylenediamine (MPD). This was coated on the PVDF surface. After 10 min, 0.3 wt. % trimesoyl chloride (TMC) in n-hexane was introduced to polymerized on with phenylenediamine (MPD).

### Example 4—Separation Performance of the Prepared Membranes

The prepared membrane with an area of 36 cm² was fitted to the set-up cell provided by Sterlitech Company. The membrane permeability for pure solution and salt solution was measured. It was tested as a function of time under a pressure of 400 psi and room temperature. The permeate water was gathered in a specific cylinder for 4 min in many intervals of time. The experiment was run for around 3 hours in distilled water and after that, the salt/oil solution was added and run for additional 3 hours. Before taking the real readings, the membrane was run for around 1 hour until attaining steady flux. In order to test the salts and hydrocarbons rejection, a 1000 ppm concentration of each salt including NaCl and MgSO₄ salts was added to the feed tank. Also, 100 ppm of lead and cadmium were added. Also, 100 ppm concentration of each hydrocarbon including hexadecane, n-heptane, and toluene was also added to the feed tank. While adding the salt/oil solution to the tank, the feed solution was stirred continuously to exclude any polarization effect. The following two equations were used to calculate the permeability and rejection of the membranes.

$$J = \frac{v}{At} \qquad ( Equation 1 )$$

$$R ( \% ) = ( 1 - \frac{{C}_{per}}{{C}_{feed}} ) \times 100 \qquad ( Equation 2 )$$

Where J is the permeate flux (L/m²·h), V is the volume of the collected permeate water at a certain time (L), A is the effective area (m²) of the prepared membrane, t is the time elapsed in collecting the permeated sample (h), R is salt/oil rejection (%), Cₚₑᵣ is the concentration of the permeated water, and C_{feed} is the concentration of the feed tank. The measurements were applied to two specimens for each membrane type and averaged to obtain the final values.

The ability or effectiveness of the produced composite membrane to reject salts, heavy metals, and some organic contaminants from the treated wastewater was examined. The prepared membranes showed a steady rejection of several pollutants including salts species (Cl, Mg, Ca, and SO₄). The findings are consistent with the Donnan mechanism, which states that divalent ions are more removed than monovalent ions.

The rejection findings were analyzed to compare the stable retention capacity of the developed membranes against salts, heavy metals, and hydrocarbons. The high rejection obtained by the modified membranes indicates that the modified membranes of the present disclosure have better compact structure and higher functional groups than the non-modified membrane (membranes without the addition of Al-based structure).

The removal efficiency of the example membrane toward organic contaminants and heavy metals are higher compared to salts. The membrane displayed a rejection of around 90% of heavy metals (Pb, Cr, Cd, Ni ions). It shows also high rejection of organic pollutants. The membrane displayed a rejection of 75% SO4, 91% Ca, 89% Mg, and 78% Cl. The high heavy metals rejection can be explained by that nitrogen has a strong affinity for Cr, Cd, Pb, and Ni ions atoms. The adsorbed ions produced a second layer that repelled the co-ion, resulting in a higher rejection rate. The continuous development of ionic pressure from separated solutes and impurities collecting on the membrane surface might be referred to as the decline of rejection over time. Constantly applying pressure to a membrane can change its porosity properties.

These impressive findings illustrate the stability and efficacy of the membrane created in eliminating a wide spectrum of environmental contaminants usually seen in actual wastewater.

Embodiments disclosed herein include:
A. [Methods include synthesizing an amine-modified metal oxide, wherein the amine-modified metal oxide comprises a metal oxide component and a water-soluble amino acid derivative having a 1:1 ratio of metal oxide components to water-soluble amino acid derivative; dissolving a water-soluble polymer and a polyvinylidene fluoride and the amine-functionalized metal oxide to form a polymer solution; casting the polymer solution into a mold to form a substrate membrane; coating the substrate membrane with a polyamide; and forming a membrane, wherein the amine-functionalized metal oxide is covalently connected to the polyvinylidene fluoride.]
B [Methods include flowing wastewater through a membrane comprising a polyamide and polyvinylidene fluoride grafted with an amine-functionalized metal oxide. The amine-functionalized metal oxide comprises a metal oxide component and a water-soluble amino acid derivative having a 1:1 ratio of metal oxide components to water-soluble amino acid derivative.]
C [A membrane comprising: polyamide and polyvinylidene fluoride grafted with an amine-functionalized metal oxide, wherein the amine-functionalized metal oxide comprises a metal oxide component and a water-soluble amino acid derivative having a 1:1 ratio of metal oxide components to water-soluble amino acid derivative.]

Each of embodiments A through C may have one or more of the following additional elements in any combination: Element 1: [the amine-functionalized metal oxide further comprises a primary amine component]. Element 2: [the amino acid derivative comprises folic acid]. Element 3: [the metal oxide component comprises a silane derivative]. Element 4: [the water-soluble polymer is polyvinylpyrrolidone]. Element 5 [wastewater is a byproduct from industrial oil refinery]. Element 6 [wastewater comprises metals, oils, salts, or combinations thereof]. Element 7 [the metal oxide component comprises aluminum oxide]. Element 8 [the amine-modified aluminum oxide comprises a structure according to formula (II):

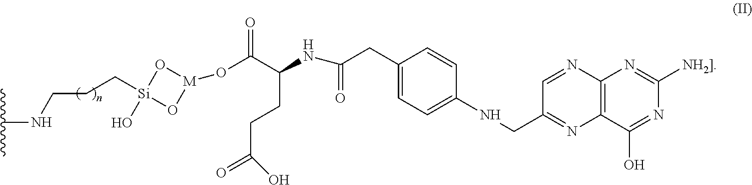

By way of non-limiting example, exemplary combinations applicable to A through C include: Element 1 with Element 2; Element 2 with Element 3; Element 3 with Element 4; Element 2 with Element 5; Element 1 with Element 6; Element 7 with Element 8; Element 9 with Element 10; Element 10 with Element 11; Element 10 with Element 12; and Element 10 with Element 13.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A method for treating wastewater, the method comprising
flowing wastewater through a membrane comprising a polyamide and polyvinylidene fluoride grafted with an amine-functionalized metal oxide, wherein the amine-functionalized metal oxide comprises a metal oxide component and a water-soluble amino acid derivative having a 1:1 ratio of metal oxide components to water-soluble amino acid derivative.

2. The method of claim 1, wherein the amine-functionalized metal oxide further comprises a primary amine component.

3. The method of claim 1, wherein the amino acid derivative comprises folic acid.

4. The method of claim 1, wherein the metal oxide component comprises a silane derivative.

5. The method of claim 1, wherein the water-soluble polymer is polyvinylpyrrolidone.

6. The method of claim 1, wherein the wastewater is a byproduct from industrial oil refinery.

7. The method of claim 6, wherein the wastewater comprises metals, oils, salts, or combinations thereof.

8. A method of producing a membrane, the method comprising:
synthesizing an amine-modified metal oxide, wherein the amine-modified metal oxide comprises a metal oxide component and a water-soluble amino acid derivative having a 1:1 ratio of metal oxide components to water-soluble amino acid derivative;
dissolving a water-soluble polymer and a polyvinylidene fluoride and the amine-functionalized metal oxide to form a polymer solution;
casting the polymer solution into a mold to form a substrate membrane;
coating the substrate membrane with a polyamide; and
forming a membrane, wherein the amine-functionalized metal oxide is covalently connected to the polyvinylidene fluoride.

9. The method of claim 8, wherein the amine-functionalized metal oxide further comprises a primary amine component.

10. The method of claim 8, wherein amino acid derivative comprises folic acid.

11. The membrane of claim 8, wherein the metal oxide component comprises a silane derivative, an aluminum oxide, or both

12. The membrane of claim 8, wherein the amine-modified aluminum oxide comprises a structure according to formula (II):

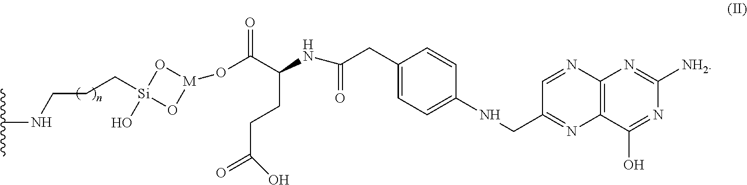

13. A membrane comprising:
polyamide and polyvinylidene fluoride grafted with an amine-functionalized metal oxide, wherein the amine-functionalized metal oxide comprises a metal oxide component and a water-soluble amino acid derivative having a 1:1 ratio of metal oxide components to water-soluble amino acid derivative.

14. The method of claim 13, wherein the amine-functionalized metal oxide further comprises a primary amine component.

15. The method of claim 13, wherein amino acid derivative comprises folic acid.

16. The membrane of claim 13, wherein the metal oxide component comprises a silane derivative, and aluminum oxide, or both.

17. The membrane of claim 13, wherein the amine-modified aluminum oxide comprises a structure according to formula (II): [chemical structure]
